(19) United States
(12) Patent Application Publication
(10) Pub. No.: US 2010/0117029 A1
(43) Pub. Date: May 13, 2010

(54) FORMING CROSSLINKED-GLUTATHIONE ON NANOSTRUCTURE

(76) Inventor: Jackie Y. Ying, Nanos (SG)

Correspondence Address: KLARQUIST SPARKMAN, LLP, 121 SW SALMON STREET, SUITE 1600, PORTLAND, OR, 97204, US

(21) Appl. No.: 12/598,192

(22) PCT Filed: Apr. 30, 2008
(86) PCT No.: PCT/SG2008/000152

§ 371 Date: Oct. 29, 2009

Related U.S. Application Data
(60) Provisional application No. 60/924,093, filed on Apr. 30, 2007.

(51) Int. Cl. C09K 11/02; B05D 7/00

(52) U.S. Cl. 252/301.36; 427/214; 427/216; 977/774; 977/734; 977/762; 977/892; 977/904

(57) ABSTRACT

In a method of forming a light emissive nanostructure, a quantum dot is provided and a crosslinked-glutathione layer around the quantum dot is formed. The light emissive nanostructure thus comprises a quantum dot and a crosslinked-glutathione layer around the quantum dot. In another method, a metal-based nanostructure is provided, and a crosslinked-glutathione layer coated on a surface of the metal-based nanostructure is formed. The metal-based nanostructure is thus coated with a crosslinked-glutathione layer. To promote crosslinking and stability, the glutathione layer may be crosslinked in the presence of an activating agent and sufficient amount of free glutathione.

### CROSS-REFERENCE TO RELATED APPLICATION

This application claims the benefits of U.S. provisional application No. 60/924,093, filed Apr. 30, 2007, the contents of which are incorporated herein by reference.

### FIELD OF THE INVENTION

The present invention relates to nanostructures, and methods of forming a layer on a nanostructure.

### BACKGROUND OF THE INVENTION

Fluorescent semiconductor nanocrystals or quantum dots (QDs) are useful as optical probes in biological imaging. For many applications, the QDs need to be “capped” in an outer layer formed of a more stable and water-soluble material.

Such materials that are known include some polymers or silica. However, it is difficult to form a layer of such materials with a thickness less than about 3 nm depending on the material and the QDs. Thus, QDs capped with such materials typically have relatively large diameters, in the range of 12 to 25 nm. Large QDs have limited application. For example, they are not suitable for use with smaller targets such as antibodies.

Known capping materials also include some bi-functional thiol-containing ligands. QDs capped with such materials can be water soluble. QDs capped with mono-thiol ligands such as thioacetic acid can also have relatively small sizes. However, a cap formed of mono-thiol ligands is not very stable in water and tends to gradually dissociate from the quantum dot in an aqueous solution. A cap formed of multi-thiol ligands can be more stable but it is difficult to make the cap thin. Typically, QDs capped with multi-thiol ligands have diameters up to 22 to 30 nm.

### SUMMARY OF THE INVENTION

Therefore, according to an aspect of the present invention, there is provided a method of forming a light emissive nanostructure, in which a quantum dot is provided and a crosslinked-glutathione layer around the quantum dot is formed. The quantum dot may be provided with glutathione around it, and the glutathione around the quantum dot may be crosslinked. The crosslinking may comprise mixing the glutathione around the quantum dot with an activating agent and free glutathione in a solution, thus to react the glutathione with the activating agent in the presence of the free glutathione. The solution may comprise a plurality of glutathione-capped quantum dots, and the molar ratio of free glutathione to quantum dots in the solution may be higher than 100, such as in the range of about 100 to about 5000. The molar concentration of the quantum dots in the solution may be from about 0.01 μM to about 100 μM. The solution may comprise water. The solution may comprise an organic solvent. The activating agent may comprise carbodiimide. The carbodiimide may be 1-ethyl-3-(3-dimethylaminopropyl)carbodiimide hydrochloride (EDC) or diisopropyl carbodiimide (DIC), or a combination including EDC and DIC. The activating agent may comprise N-hydroxysuccinimide (NHS). The crosslinked-glutathione layer around the quantum dot may have an external diameter of less than 12 nm, such as from about 4 to about 7 nm. The quantum dot may comprise a CdTe, CdSe, ZnSe, ZnCdSe, CdS, ZnS, PbS, Ag, or Au crystal. The quantum dot may be a CdTe crystal. The quantum dot may comprise a CdSe crystal core, a first shell around the core, and a second shell around the first shell. The first shell comprises CdS and the second shell comprises ZnS.

According to another aspect of the present invention, there is provided a light emissive nanostructure comprising a quantum dot and a crosslinked-glutathione layer around the quantum dot. The light emissive nanostructure may have an external diameter of less than 12 nm, such as from about 4 to about 7 nm. The quantum dot may comprise a CdTe, CdSe, ZnSe, ZnCdSe, CdS, ZnS, PbS, Ag, or Au crystal. The quantum dot may be a CdTe crystal. The quantum dot may be a CdTe crystal. The quantum dot may comprise a CdSe crystal core, a first shell around the core, and a second shell around the first shell. The first shell comprises CdS and the second shell comprises ZnS.

In accordance with a further aspect of the present invention, there is provided a method of coating a nanostructure, in which, a metal-based nanostructure is provided, and a crosslinked-glutathione layer coated on a surface of the metal-based nanostructure is formed. The nanostructure may have a volume of less than 0.001 μm³, and the crosslinked-glutathione layer may be formed by crosslinking glutathione coated on the nanostructure. The nanostructure may be a metal-based nanotube, nanoneedle, nanorod, or nanowire. The nanostructure may comprise Cd, Zn, Pb, Cu, Ag, Au, or Hg.

In accordance with yet another aspect of the present invention, there is provided a metal-based nanostructure coated with a crosslinked-glutathione layer.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic diagram for a method of forming or coating a nanostructure, exemplary of an embodiment of the present invention;

FIGS. 2 and 3 are line graphs showing absorbance (dashed lines) and fluorescence (solid lines) spectra of sample quantum dots;

FIGS. 4 and 5 are line graphs showing distribution of particle sizes of sample quantum dots;

FIGS. 6 and 7 are transmission electron microscopy (TEM) images of sample quantum dots;

FIGS. 8, 9, 10, and 11 are fluorescence images of cells incubated with sample quantum dots prepared according the method of FIG. 1;

FIGS. 12 and 13 are TEM images of magnetic particles conjugated with sample quantum dots prepared according the method of FIG. 1; and

FIGS. 14 and 15 are fluorescence images of cells incubated with magnetic particles including sample quantum dots prepared according the method of FIG. 1.

### DETAILED DESCRIPTION

It has been discovered that relatively stable, small sized light emissive nanostructure can be formed by forming a crosslinked-glutathione (cGSH) layer around a quantum dot (QD). As described herein, it is possible to form a thin layer of cGSH on a QD in a relatively simple process. The external diameter of the cGSH-capped QDs can thus be made small. Because the glutathione (GSH) in the layer is crosslinked, the cGSH layer is less likely to disintegrate and dissociate from the QD. Thus, the cGSH layer (or cap) can remain relatively stable over a long period of time in a solution such as an aqueous solution.

It has also been discovered that, as described below, inter-particle crosslinking can be reduced by adding sufficient free GSH during the crosslinking process, to prevent particle aggregation. Thus, cGSH-capped QDs with a narrow diameter/size distribution can be obtained.

Capped QDs herein may be referred to as GSH capped QDs, and may be written in the form GSH-QDs. In this paper, when a layer of GSH in the cap is mostly crosslinked, the capped QD may be represented as cGSH-QD, and when the GSH in the cap is mostly not crosslinked (“un-crosslinked”), the capped QD may be represented as uGSH-QD. QDs with a core-shell structure are also commonly represented in the form of shell material-core material as further detailed below.

In an exemplary embodiment of the present invention, a capped QD is formed of a QD and a layer of cGSH. The layer of cGSH may have a thickness as small as from about 1 to about 3 nm. The capped QD may have a total diameter of less than 12 nm, such as from about 4 to about 7 nm, where the quantum dot itself may a diameter of about 3 to about 4 nm.

The QDs may be of a generally spherical shape but may also have other shapes such as a rod-like shape. The sizes of the QDs or can vary but are typically selected so that they are within a defined range to provide the desired properties such as a desired fluorescence emission spectrum. While the shapes of the QDs may vary, it is common to specify their sizes by their “diameters.” The diameter of a QD or particle refers to its average or effective diameter. An effective diameter of a non-spherical particle is the diameter of a spherical particle that has the same volume as the non-spherical particle. The diameters/sizes of particles may be measured using any suitable technique including mechanical, optical or electronic imaging techniques. For example, the external or internal diameters of QDs or other particles may be measured using a light scattering technique, or may be determined from transmission electronic microscopy (TEM) images of the QDs or other particles. Another technique to measure the external diameters of particles is to filter the particles through suitable filters of different pore sizes.

A QD herein refers to a nanostructure, such as a nanoparticle, wherein the motion of conduction band electrons, valence band holes, or excitons (bound pairs of conduction band electrons and valence band holes) is confined in all three spatial dimensions. Typically, a QD includes a photostable color-tunable nanocrystal core with a wide absorption spectrum and a narrow (fluorescence) emission peak. A nanostructure or nanoparticle refer to structures or particles that have a characteristic dimension of about 100 nm or less. The characteristic dimension is a dimension that affects or defines a physical or chemical characteristic of the structure. For example, the external diameter is a characteristic of the QD or a particle. The emission spectrum of a QD may be affected by its core diameter and external shell diameter. For many applications, the desired characteristic dimension of QDs, such as their external or core diameters, is as low as from about 3 to about 10 nm.

The QD may be formed of any suitable material and may have any suitable structure. The QD may have a core formed of a heavy metal based crystal structure. The QD may also have a heavy-metal based intermediate shell. The surface material of the QD should be compatible with a GSH coating. That is, a GSH layer should be able to be formed around the QD, or coated on the QD surface, and the resulting capped QD should remain relatively stable. In some cases, some materials such as GaN QDs or some other QDs made of row III-V elements in the elemental table may not be compatible with the GSH coating and thus should be avoided. In some embodiments, a metal surface and a GSH coating may form electrostatic metal-S bond therebetween, which may assist to prevent desorption of the GSH and to promote crosslinking between the GSH molecules.

For example, the QD may include a crystal such as a CdTe, CdSe, ZnSe, or ZnCdSe semiconductor nanocrystal, or another suitable crystal such as PbS, PbSe or the like. As noted above, the QD may have a core-shell structure, or have an inner-crystal/first-shell/second-shell structure. In an exemplary embodiment, the QD may be a CdTe nanocrystal. In another exemplary embodiment, the QD may have a CdSe/CdS/ZnS structure.

In other embodiments, other types of nanocrystals and QD materials may be used in the QD, including CdS, ZnS, PbS, PbSe, Ag, Au, or the like.

A QD is capable of fluorescence when it is excited. Typically, the fluorescence emission spectrum of QDs is narrow and well defined, and can be selected (tuned) for different applications, such as by controlling its size, including core and shell sizes, as can be understood by persons skilled in the art.

The cap of the QD may be formed of one or more layers around the QD. For example, the cap may be formed of one or more GSH layers, and may optionally include one or more other coating materials either in a GSH layer or in a separate layer. Where there are multiple layers, it may be advantageous that the cGSH layer is the outermost layer. However, the cGSH layer may be further coated by another layer of desired material in some applications. When there are multiple layers of GSH, only the outer most layer needs to be crosslinked. The inner GSH layer(s) may remain un-crosslinked.

Crosslinking refers to attachment of two chains of polymer molecules by primary chemical bonds, such as covalent or ionic bonds, between certain carbon atoms of the chains. A cGSH layer refers to a layer in which the GSH molecules are sufficiently crosslinked with one another so that the crosslinked GSH form a stable network, even when the layer is immersed in an aqueous solution. As can be understood, it is not necessary that all of the GSH molecules in the layer are crosslinked, or each GSH molecule be fully crosslinked.

Glutathione (GSH) is a tripeptide, consisting of glutamic acid, cysteine and glycine. Each GSH molecule contains an amine group, two carboxylate groups and a thiol group. Two GSH molecules can be crosslinked by forming an amide between a carboxylate group on one molecule and the amine group on the other molecule. The thiol group on the cysteine residue of the GSH can function as a capping ligand for binding the GSH to the QD. Many of the functional groups on the cGSH remain available and accessible for binding with other species, such as for conjugation with bioprobes.

Unlike simple monothiol ligands, each GSH molecule contains one amine group and two carboxylate groups. Besides imparting water solubility, these functional groups also provide the possibility of being coupled and further crosslinked to form a polymerized structure.

It is known that in plant cells, GSHs would bind to heavy metal nanoclusters, and an enzyme called phytochelatin synthase would act to join two separate GSH molecules through forming an amide bond between their carboxylate group and amine group. This layer of coating, or “phytochelatin”, formed by polymerized or crosslinked glutathione greatly stabilizes heavy metal nanoclusters and prevents them from harmful leaching.

Without being limited to any particular theory, a layer of cGSH is expected to provide a similar functionality as a phytochelatin coating provides in phytochelatin-coated heavy metal nanoclusters in plant cells, and is expected to enhance the stability of the capped QDs, without materially diminishing the QD's optical property and biocompatibility.

Indeed, test results show that sample QDs capped with cGSH are highly water-soluble, stable and biocompatible in various cell culture media, see examples below.

Various bio-probes such as doxorubicin can be conveniently linked to the glutathione in the capping layer by conjugation with its amine, thiol or carboxylate groups. Thus, the capped QDs can be conveniently used in bio-imaging, sensing, labeling, and other similar applications, and can be used with smaller sized targets such as antibodies, with improved efficiency, as compared to QDs coated with conventional polymeric or silica capping materials.

As compared with QDs capped by conventional thiol-containing capping materials, it is expected that cGSH-capped QDs can provide higher quantum yields, greater stability in aqueous solutions with a wider pH range, and higher biocompatibility in cell culture.

For example, cGSH-capped QDs can be used as bio-tags for in vitro and in vivo bioimaging. They can also be used as fluorescent probes for detection of various DNA or proteins. Nanocomposites containing magnetic nanoparticles conjugated with these capped QDs can be used for simultaneous bio-labeling, bio-imaging, cell sorting, and targeting.

In an exemplary embodiment, the capped QDs may be prepared in the process described next.

A solution containing GSH-capped QDs is first prepared or obtained. A layer of un-crosslinked GSH (uGSH) is formed around the individual QD. It is not necessary that in the layer of uGSH that no GSH molecule is crosslinked with another GSH molecule or another different molecule. However, at least most of the GSH molecules within the layer are not crosslinked to one another such that the layer of uGSH will substantially disintegrate from the QD when immersed in an aqueous solution over an extended period of time such as more than a day.

The QDs may be prepared according to any suitable technique including conventional techniques for preparing the particular quantum dot to be capped. For instance, exemplary techniques that can be used in a process for forming QD or precursors are disclosed in, e.g., B. J. Nehilla et al., “Stooichiometry-dependent formation of quantum dot—antibody bioconjugates: a completmentary atomic force microscopy and agarose Gel Electrophoresis Study,” J. Phys. Chem. B, 2005, vol. 109, pp. 20724-20730; F. Pinaud et al., “Bioactivation and Cell Targeting of Semiconductor CdSe/ZnS Nanocrystals with Phytochelatin-Related Peptides,” J. Am. Chem. Soc., 2004, vol. 126, pp. 6115-6123; W. Jiang et al., “Design and Characterization of Lysine Cross-Linked Mercapto-Acid Biocompatible Quantum Dots,” Chem. Mater., 2006, vol. 18, pp. 872-878, the entire contents of each of which are incorporated herein by reference.

Suitable process for forming a uGSH layer around the QD will depend on the QD to be capped as will be appreciated by those skilled in the art.

Some suitable techniques for forming a uGSH layer around a QD have been disclosed in the literature. For example, uGSH-capped CdTe, CdSe, ZnSe, and ZnCdSe QDs may be respectively formed in an aqueous solution using a technique disclosed in Y. Zheng et al., “Synthesis and Cell-imaging Applications of Glutathione-Capped CdTe Quantum Dots”, Adv. Mater., 2007, vol. 19, pp. 376-380; M. Baumle et al., “Highly Fluorescent Streptavidin-Coated CdSe Nanoparticles: Preparation in Water, Characterization, and Micropatterning”, Langmuir, 2004, vol. 20, pp. 3828-3831; Y. Zheng et al., “Aqueous Synthesis of Glutathione-capped ZnSe and Zn₁₋ₓCdₓSe Alloyed Quantum Dots”, Adv. Mater., 2007, vol. 19, pp. 1475-1479, the entire contents of each of which are incorporated herein by reference.

In an embodiment, the un-crosslinked glutathione molecules in the layer around the QD are crosslinked by mixing them with a coupling or activating agent and additional free glutathione in the solution. As a result, the un-crosslinked glutathione molecules in the layer around the QD react with the activating agent in the presence of free glutathione.

The additional glutathione functions as both a crosslinker and a stabilizer, as will become clear below. A sufficient amount of additional free GSH is added to the solution to prevent aggregation of the QDs.

The coupling or activating agent may be any substance that will activate the terminal groups on the GSH molecules for binding with another molecule.

Carbodiimide is a suitable coupling agent for this purpose.

N-hydroxysuccinimide (NHS) may also be added to the solution as an additional coupling agent. When NHS is present in the solution, the yield of the desired amide products can increase due to the formation of a more stable intermediate (NHS ester), and the fact that this intermediate can react with the primary amine group more specifically.

In another embodiment, quantum dots capped with a layer of uGSH may be provided and the GSH in the layer may be crosslinked using another crosslinking method.

In this embodiment, the solution is an aqueous solution which includes water as a solvent. The solution may optionally include an organic solvent such as dimethylformamide (DMF) or dimethylsulfoxide (DMSO), methanol or the like.

In some other embodiments, the QDs may be provided in a non-aqueous solution and the GSH may be crosslinked in the non-aqueous solution. However, using an aqueous solution may provide certain benefits, such as better solubility and reduced cost.

In cases where the QDs are initially water insoluble or have been prepared in a non-aqueous solution, they may be made water soluble by first forming a uGSH layer around the QD and the subsequent transfer to an aqueous solution or into an aqueous phase of the same solution before crosslinking. For example, CdSe/CdS/ZnS QDs may be synthesized via an organometallic route and are initially dissolved in an organic solvent in an aqueous solution, and are then capped with GSH to become water soluble and transferred into an aqueous phase in the solution.

In this embodiment, carbodiimide is used to link the carboxylate group and the amine group on two separate GSH molecules in a simple chemical process, which does not involve phytochelatin synthase. This chemical process is expected to proceed as follows: a carboxylate group of one GSH molecule reacts with carbodiimide to initially form a highly reactive intermediate, O-acylisourea, which reacts with the amine group on another GSH molecule to form a stable amide bond.

Either 1-ethyl-3-(3-dimethylaminopropyl)carbodiimide hydrochloride (EDC) or diisopropyl carbodiimide (DIC) may be used as the carboxylate activating agent.

EDC is soluble in both organic solvents and in water or an aqueous solution.

DIC is only soluble in an organic solvent such as DMF or DMSO. While either EDC or DIC may be used as the activating or coupling agent, the use of DIC may require the use of an organic solvent such as DMF or DMSO.

DIC may be used with no water, or may be used in a solution containing both water and a suitable organic solvent.

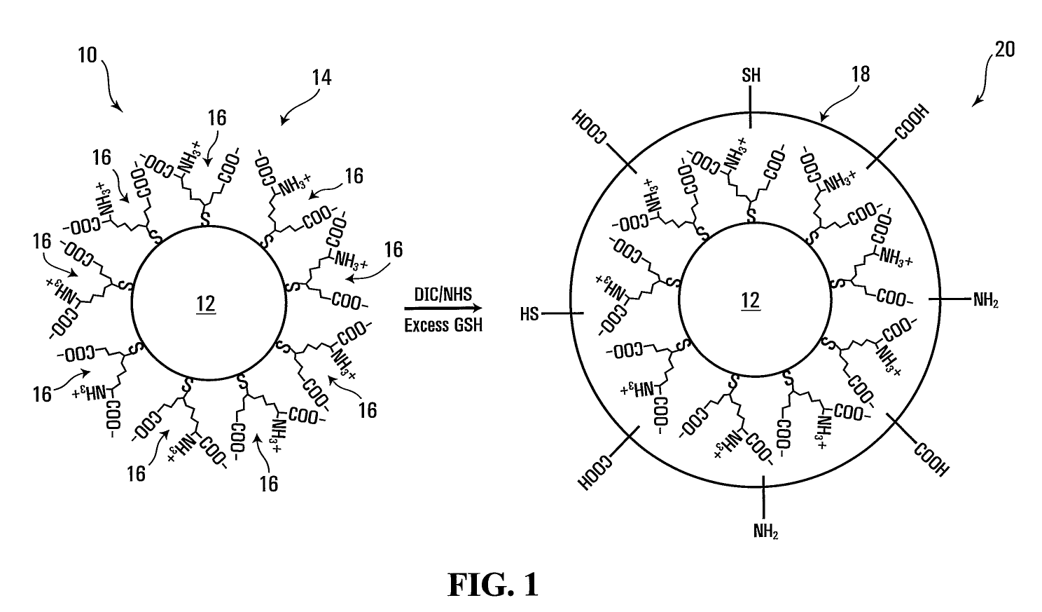

The processing procedure according to this embodiment is schematically illustrated in FIG. 1, with DIC/NHS shown as the coupling or activating agent. Initially, the capped QD 10 has a QD 12 capped with a monolayer 14 of un-crosslinked GSH 16. After the capped QD 10 is mixed with DIC/NHS and excess GSH in an aqueous solution, a layer 18 of crosslinked GSH is formed around QD 10, forming a cGSH capped QD (cGSH-QD) 20.

Mixing of the ingredients in the solution may be effected in any suitable manner. Typically, NHS and NaOH need to be added before adding DIC. The various ingredients may have a concentration in the range of 1 mM to 100 mM. For example, to promote sufficient mixing, the solution may be stirred using any suitable technique when new ingredients are added. Continued stirring may be necessary during subsequent reactions or incubation.

It has been found that if the amount of free GSH in the solution is too low, after the GSH on the QDs have been activated by the coupling agent, either EDC/NHS or DIC/NHS, the QDs tend to aggregate.

One of the possible reasons for this is inter-particle crosslinking, which is undesirable. That is, GSH molecules from different QDs become crosslinked. The desired crosslinking is crosslinking between GSH molecules in the shell of the same QD. It can be difficult to prevent inter-particle crosslinking as a QD with an activated carboxylate group will likely encounter another QD with an accessible, reactive amine group. One apparent possible measure to reduce such inter-particle cross-linking is to lower the concentration of QDs in the solution, thus reducing the rate of inter-particle collision. However, test results show that this measure is not sufficient to prevent aggregation over a relatively long period of time (such as a few hours) even at very low QD concentrations such as about 0.1 μM.

It has been recognized that another possible cause for aggregation is the desorption of GSH from the QD surface after they have been activated by the coupling agent, such as carbodiimide/NHS. The free (desorbed) activated GSH molecules tend to react with the amine groups of other free GSH molecules, instead of being re-adsorbed back onto the QDs. Consequently, after a period of time, the coupling between free GSH may become dominant, and the “de-capped” QDs will gradually aggregate.

It has been discovered that adding an excessive amount of free GSH to the solution overcomes these potential problems. It has been found that for some applications, it is sufficient to add an amount of free GSH so that the molar concentration of the GSH capped QDs is less than one percent of the molar concentration of free GSH in the solution (this limit may vary somewhat depending on the size/diameter of the QDs). For example, the molar ratio of the free GSH to QDs in the solution may be in the range of about 100 to about 5000. The absolute molar concentration of the QDs in the solution may be in the range of about 0.01 μM to about 100 μM. The absolute molar concentration of GSH in the solution may be in the range of about 10 μM to about 500 mM. The amount of free GSH added to the solution may also be selected to control the thickness of the c-GSH coating formed.

It is expected that when the molar concentration of the QDs is very low as compared to that of free GSH, such as by a factor of about 1:100 to about 1:5000, the probability of inter-particle crosslinking is substantially reduced, even when the absolute QD concentration is relatively high. The activated carboxylate group on GSH tethered on a QD is more likely to couple with the amine group from either a nearby GSH on the same QD or a free GSH in the solution. The chance to crosslink with GSH on another QD is significantly reduced as each QD is surrounded by many free GSH molecules. In addition, due to the large concentration difference, the dynamic balance between GSH adsorption and desorption also favors adsorption. Thus, the two potential causes for aggregation can be both suppressed.

The test results seem to support the above reasoning. In the tests conducted, no significant particle aggregation was observed even after a relatively long period (e.g. overnight to over a week) of incubation when a large amount of excess free GSH was present in the solution. The fact that cGSH-QDs do not aggregate after carboxylate activation, such as by EDC/NHS, over a wide concentration range 0.1 mM to 500 mM suggests that the aggregation of GSH-QDs is more likely due to the GSH desorption from the QD surface, as compared to inter-particle crosslinking, which would only be of significance at higher QD concentrations.

The pH of the solution may vary from about 6 to about 9.

After the GSH on the QDs are sufficiently crosslinked, such as after about 8 hours of incubation at room temperature under ambient pressure, the cGSH-QDs may be extracted, such as by known purification, precipitation and ultrafiltration techniques for removing unreacted reagents and other reaction products.

Depending on the particular applications, other additional materials or additives may be added to the solution before or during incubation.

The duration of incubation may be extended or shortened to control the thickness of the c-GSH coating formed.

It has been found that c-GSH capped QDs provide improved stability over uGSH capped QDs. Although the colloid stability of uGSH capped QDs is generally better than QDs capped by other monothiol ligands, uGSH may slowly desorb from the QD surface, resulting in particle aggregation. The increased stability of cGSH-QDs can facilitate the conjugation with bioprobes.

The c-GSH-QDs can not only be used for labeling specific targets on fixed cells by immunostaining, or for binding to receptors on live cell membranes, but can also be used in a wide range of other applications, due to the wide range of their possible sizes or diameters, which can be less than about 12 nm. For example, when the cGSH-QDs have a diameter comparable to or less than the typical size of antibodies (12 to 15 nm), it is possible to conjugate many such QDs with each antibody (see Example section below). By contrast, it has been postulated that no more than one large QD (e.g. of a diameter of 15-20 nm) can be conjugated to a single antibody. Further, smaller QDs may likely have less impact on the activities of the conjugated antibodies, while larger QDs may significantly hamper the activities of the antibodies, especially if the active sites of the antibodies are blocked by the bulky QDs attached. Thus, it is expected that QDs with diameters less than 12 nm can significantly improve target accessibility and labeling efficiency of QD-based systems.

For example, the small sized cGSH-QDs can be conjugated with small probes, such as doxorubicin or magnetic nanoparticles.

Nanocomposite particles formed of both fluorescence QDs and magnetic nanoparticles (MPs) (e.g. iron oxides) can have applications in cell imaging, labeling and separation. Several strategies have been developed to produce such nanocomposite particles. However, the fluorescence of such QDs often suffered from quenching by the MPs when the MPs content is too high. It is thus advantageous to be able to control the sizes and loadings (relative molar ratio) of the QDs and MPs, so as to manipulate the fluorescence properties and minimize the quenching effect of MPs. With smaller sized cGSH capped QDs, more QDs can be conjugated with each MP. It is expected that potentially up to 500 QDs may be conjugated with each MP.

Conjugation of antibodies with bifunctional nanoparticles formed of MP and cGSH-QDs can allow targeting of specific cell types in cell labeling, imaging, manipulation and separation.

The embodiments described herein may be modified for the particular needs in particular applications. As can be appreciated, the exemplary processes and methods described herein, or their variations, may be used or adapted to form a crosslinked peptide coating on the surface of various QDs or other core or substrate materials, where the thickness of the coating layer can be controlled and can be as thin as about 0.5 nm.

A cGSH layer may be formed on a surface of a substrate to form a coating that covers all or only a portion of the substrate surface. As can be understood, for some applications, when the surface of the substrate is even partially coated with a layer of cGSH, improved water solubility can be achieved. Further, in some applications, only a certain area on the surface may require further protection or solubility provided by the cGSH layer.

The core or substrate material is not limited to semiconductor nanocrystals. Other core or substrate materials that can be protected by a layer or coating of cGSH include heavy metal or noble metal nanoparticles, various metal-based nanostructures such as metal-based nanotubes, nanowires, nanorods, nanoneedles, or the like. A metal-based nanostructure refers to a nanostructure that contains a heavy metal as one of its characterizing ingredients on its surface. For example, the metal or noble metal materials and metal-based nanostructures may be formed of one or more of the following materials: Cd, Zn, Pb, Cu, Ag, Au, Hg, or heavy-metal-containing nanoparticles.

For example, magnetic metal core materials may be coated with c-GHS to render it soluble and stable in water.

The nanoparticles or nanostructures have a characteristic size less than about 100 nm. The nanostructures or metal nanoparticles may have an individual volume smaller than about 0.001 μm³. The resulting particle may have a core-shell structure where the shell includes a layer of cGSH and the core has a volume of smaller than about 0.001 μm³.

The exemplary embodiments of the present invention are further illustrated with the following non-limiting examples.

### EXAMPLES

For these examples, diisopropyl carbodiimide, sodium hydroxide, zinc chloride, cadmium chloride, aluminum telluride, zinc acetate, and cadmium acetate were obtained from Lancaster™; trioctylamine (TOA), trioctylphosphine (TOP), oleic acid, cadmium oxide (CdO), cadmium acetate dehydrate, selenium (Se) powder (200 mesh), L-glutathione, sulfur powder, and NHS were obtained from Sigma-Aldrich™; octadecylphosphonic acid and cetyltrimethylammonium bromide (CTAB) were obtained from Alfa™, unless otherwise specified. These chemicals were all of a high purity grade, which is more precisely indicated below for some of these chemicals.

### Example I

### Synthesis of uGSH-CdTe QDs

All reactions in this example were performed in oxygen-free water under argon. The synthesis of CdTe QDs was based on the reaction of cadmium chloride with hydrogen telluride. The tellurium precursor, H₂Te, was prepared by adding 0.5 M of sulfuric acid drop-wise to a lump of aluminum telluride (Al₂Te₃). Freshly generated H₂Te gas was bubbled into a solution containing CdCl₂ and GSH at pH 11.5 with vigorous stirring. The amounts of Cd, Te and GSH were 5, 1 and 6 mmol, respectively, in a total volume of 500 ml. The resulting dark yellow mixture was heated to 95° C., and the growth of GSH-CdTe QDs took place immediately.

The fluorescence of the QDs changed from green to red in 90 min. The as-prepared QDs were precipitated with an equivalent amount of 2-propanol, and then re-dissolved in water and precipitated with 2-propanol three more times. Pellets of purified uGSH-CdTe QDs were dried at room temperature in vacuum overnight, and the final product was in the powder form and could be re-dissolved in water.

### Example II

### Synthesis of CdSe/CdS/ZnS QDs

CdSe/CdS/ZnS QDs capped with trioctylphosphine oxide (TOPO) were synthesized by an organometallic route, based on (with minor modifications) the method disclosed in S. Jun et al., “Synthesis of multi-shell nanocrystals by a single step coating process,” Nanotechnology, 2006, vol. 17, pp. 3892-3896, the entire contents of which are incorporated herein by reference.

1 mmol of CdO powder (99.99+%) and 2 mmol of octadecylphosphonic acid were mixed in 50 ml of TOA (95%). The mixed solution was degassed and heated to 150° C. with rapid stirring, and then the temperature of the solution was increased up to 300° C. under N₂ gas flow. At 300° C., 10 ml of 2.0 M Se in TOP (90%) were quickly injected into the Cd-containing reaction mixture. After 2 minutes, the product was cooled to 50 to 60° C., and an organic sludge was removed by centrifugation (5600 rpm). Ethanol (Fisher™, HPLC grade) was added to the CdSe solution until an opaque flocculation appeared.

The CdSe nanocrystals were separated out by further centrifugation, and were then dissolved in 5 ml of toluene. For coating the CdS/ZnS shell onto the CdSe core in one run, typically 0.2 mmol of cadmium acetate dihydrate (98%), 1 mmol of zinc acetate (Aldrich, 99.99%) and 4 mmol of oleic acid (95%) were mixed in 50 ml of TOA. It was heated to and degassed at 150° C., and further heated to 300° C. under N₂ flow. 5 ml of the CdSe solution in toluene was injected into the Cd- and Zn-containing solution. Next, 5 ml of the S/TOP solution (0.4 M) was added at 1 ml/min, and reacted at 300° C. for 2 hours. Trioctylphosphine Sulfide (TOPS) was formed in the S/TOP solution, which slowly reacted with Cd acetate and Zn acetate to form CdS and ZnS, which grew on the surface of CdSe seed crystals.

Cooling and separation were performed in the same manner as described earlier. After washing with ethanol thrice, the final pellets containing TOPO-capped CdSe/CdS/ZnS QDs were dissolved in 40 ml of chloroform at a concentration of 10 mg/ml.

### Example III

### Synthesis of uGSH-CdSe/CdS/ZnS QDs

In this example, uGSH capped CdSe/CdS/ZnS QDs were prepared from TOPO-capped CdSe/CdS/ZnS QDs by ligand exchange with GSH.

500 mg of GSH and 400 mg of sodium hydroxide (NaOH) were dissolved in 10 ml of methanol, and mixed rapidly with 10 ml of TOPO-capped CdSe/CdS/ZnS QDs (100 mg, as prepared in Example II) in chloroform.

The NaOH was added to adjust the pH in the solution, so that the thiol group in the GSH was deprotonized to thiolate in the solution. NaOH may be replaced with another suitable basic material such as KOH.

After evaporating both chloroform and methanol, 50 ml of water was added to re-suspend all precipitates. The suspension was heated to 60° C. for 10 min with stirring. After phase transfer, the uGSH-CdSe/CdS/ZnS QDs were precipitated with an equivalent amount of acetone, and re-suspended in 50 ml of water at a concentration of 2 mg/ml.

### Example IV

### Crosslinking GSH on QDs

In this example, the uGSH-QDs used were either uGSH-CdTe or uGSH-CdSe/CdS/ZnS QDs. The GSH in the uGSH shells of these QDs were crosslinked in solutions as follows.

5 ml of the uGSH-QDs (2 mg/ml) were suspended in 100 mM of borate buffer (pH 8.0) to form an initial QD solution.

30 mg of GSH, 115 mg of NHS and 48 mg of NaOH were dissolved in 5 ml of water, and mixed with the QD solution. 500 μl of DIC dissolved in 3 ml of DMF was then added to the QD solution with stirring. The reagents in the solution were allowed to react for 8 hours at room temperature. NaOH was added to adjust the pH value, and may be replaced with another suitable basic material.

25 ml of acetone was then added to the solution, upon which the capped QDs started to precipitate. The solution was centrifuged and the supernatant was decanted. The remaining pellet, which contained mainly the QDs, was re-suspended and incubated (aged) overnight in 50 ml of borate buffer (pH 8.0).

The molar ratio of QDs to free GSH in the solution was about 1:2000. The molar concentrations of QDs and free GSH were about 5 μM and about 10 mM, respectively. The molar concentrations of the other ingredients were as follows: NHS—100 mM; DIC—200 mM; NaOH—120 mM; Borate—100 mM. The pH of the solution was about 8.

After incubation, cGSH-QDs were formed in the aqueous solution.

The purified cGSH-QDs demonstrated superior colloidal stability compared to uGSH-QDs. This was illustrated through dialyzing cGSH-QDs and uGSH-QDs against 50 mM of (4-(2-hydroxyethyl)-1-piperazineethanesulfonic acid (HEPES) buffer (pH 8.5) at a QD/buffer volume ratio of 1 to 1000, with a fresh buffer change many times every day. uGSH-QDs typically aggregated after 1 to 2 days of dialysis, likely due to the GSH dissociation from the QD surface. In contrast, cGSH-QDs remained highly stable after dialysis for over one (1) week under the same conditions.

Tests were also conducted using EDC/NHS as the activating agent in a similar procedure.

### Example V

### Transferring QDs into Organic Solvents with CTAB

10 ml of an aqueous cGSH-QD solution (2 mg/ml) prepared in Example IV was rapidly mixed with 10 ml of an aqueous CTAB solution (100 mM) under vigorous stirring. The precipitate was centrifuged, vacuum dried and re-suspended in methanol or chloroform.

### Example VI

### Conjugation of Doxorubicin with cGSH-CdSe/CdS/ZnS QDs

1 ml of cGSH-CdSe/CdS/ZnS QDs (1 mg/ml) was diluted with 20 ml of borate buffer (100 mM, pH 8.0). 10 mg of NHS and 20 mg of EDC were freshly dissolved in 2 ml of borate buffer (100 mM), and were immediately added to the QD solution with stirring. After 30 min, 1 ml of doxorubicin dissolved in borate buffer (0.1 mg/ml) was added and incubated overnight. The system was then quenched with 50 mM of glycine buffer (pH 7.5).

The resulting doxorubicin-conjugated cGSH-CdSe/CdS/ZnS QDs were purified with membrane ultrafiltration (50K MWCO).

### Example VII

### Conjugation of cGSH-CdSe/CdS/ZnS QDs with SiO₂-Coated MPs

1 ml of cGSH-CdSe/CdS/ZnS QDs (1 mg/ml) was diluted with 20 ml of borate buffer (100 mM, pH 8.0). 10 mg of NHS and 20 mg of EDC were freshly dissolved in 2 ml of borate buffer (100 mM), and immediately added to the QD solution with stirring. After 30 min, 1 ml of amine-functionalized SiO₂-γ-Fe₂O₃ MPs in DMSO (1 mg/ml) was added, and incubated overnight. The system was then quenched with 50 mM of glycine buffer (pH 7.5). MP-conjugated cGSH-CdSe/CdS/ZnS QDs were purified with centrifuge and resuspended in DMSO.

The SiO₂-γ-Fe₂O₃ MPs were prepared according to the method disclosed in T. Hyeon et al., “Synthesis of Highly crystalline and monodisperse maghemite nanocrystalites without a size selection process,” J. Am. Chem. Soc., 2001, vol. 123, pp. 12798-12801, the entire contents of which are incorporated herein by reference. The MP particles had 8-nm γ-Fe₂O₃ cores and had an overall particle size (diameter) of 45 nm.

### Example VIII

### Physical Characterization

Optical and other properties of the sample c-GSH QDs were measured, the results of some of which are discussed next and shown in the drawings, in comparison with un-crosslinked samples in some cases.

Elemental analysis of sample QDs was performed on ELAN™ 9000/DRC ICP-MS™ system.

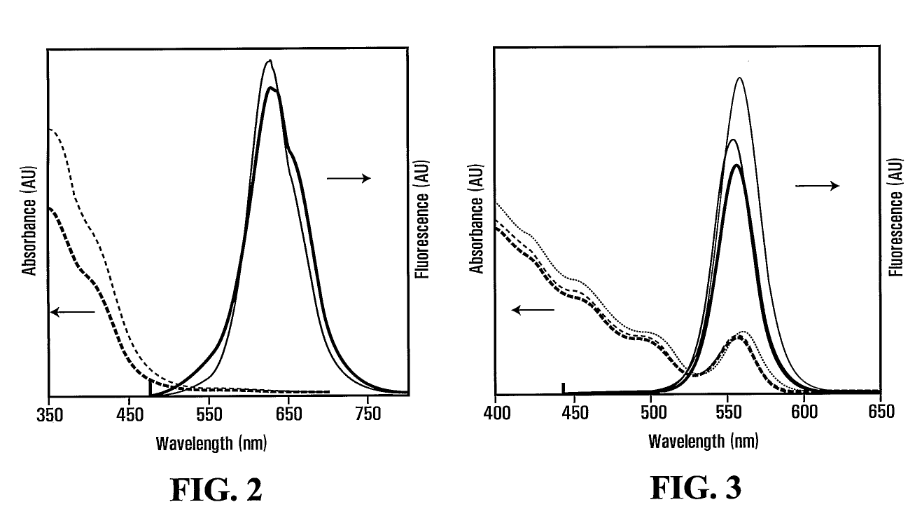

Absorption and fluorescence spectra of sample QD samples in aqueous solution were obtained at room temperature on an Agilent™ 8453 UV-Vis spectrometer and a Jobin Yvon Horiba Fluorolog™ fluorescence spectrometer, respectively. FIG. 2 shows both the absorbance (dashed lines) and fluorescence (solid lines) measured from the sample uGSH-CdTe QDs (thinner lines), and sample cGSH-CdTe QDs (thicker lines). The fluorescent properties of the GSH-QDs were maintained after crosslinking. The fluorescence spectra and quantum yields remained unchanged.

FIG. 3 shows the same measurements as in FIG. 2, but for the sample TOPO-CdSE/CdS/ZnS QDs (thin lines), uGSH-CdSE/CdS/ZnS QDs (medium-thickness lines), and cGSH-CdSE/CdS/ZnS QDs (thick lines). The measurements show a slight shift in fluorescence peak and a minor reduction in quantum yield.

Dynamic light scattering (DLS), transmission electron microscopy (TEM) and ultrafiltration were performed on the GSH-CdTe and cGSH-CdTe QDs, in part to determine their sizes/diameters.

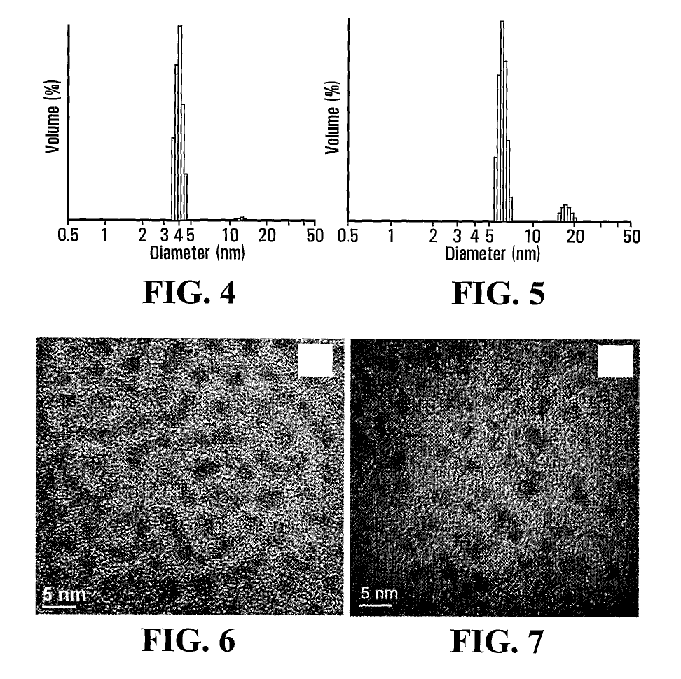

Dynamic light scattering (DLS) of QDs in aqueous solution were performed on BI-200SM laser light scattering system (Brookhaven Instruments Corporation™). FIGS. 4 (uGSH-CdTe) and 5 (cGSH-CdTe) show the distributions of particle sizes (external diameters) of the respective sample quantum dots based on the DLS measurements.

As can be seen from the figures, before crosslinking, the average external diameter of uGSH-CdTe QDs with a monolayer of GSH was about 4 to about 5 nm. Tests showed that the uGSH-CdTe QDs could pass through an ultrafiltration membrane with 50K molecular weight cutoff (MWCO), which corresponded to a pore size of about 5 nm. The cGSH-CdTe QDs were coated with multi-layers of GSH, so their external diameters were larger, about 6 to about 7 nm as can be determined from FIG. 5. As expected, the cGSH-CdTe QDs could not pass through the ultrafiltration membrane with 50K MWCO. However, most of them could pass through the membrane with 100K MWCO, which corresponded to a pore size of about 7 nm. These results confirmed that the hydrodynamic sizes or diameters of the cGSH-QDs were slightly larger than that of uGSH-QDs.

TEM images of sample QDs were obtained using an FEI Tecnai™ TF-20 field emission high-resolution TEM (200 kV). To obtain the TEM images of well-dispersed QDs, both uGSH-CdTe and cGSH-CdTe QDs were transferred into a volatile organic solvent before casting them on TEM grids. A layer of cetyltrimethylammonium bromide (CTAB) was adsorbed on the GSH layer by electrostatic interaction, so that the QDs became soluble in an organic solvents (such as chloroform).

FIGS. 6 (uGSH-CdTe) and 7 (cGSH-CdTe) show TEM images of the respective sample quantum dots. The TEM images were taken after CTAB adsorption. The uGSH-CdTe and cGSH-CdTe QDs were shown to be well dispersed with the adsorbed CTAB layer, with an average separation distance between two adjacent QDs of about 3 nm and about 5 nm, respectively. The additional layer(s) of GSH on cGSH-QDs accounted for the additional separation distance of about 2 nm, in agreement with the DLS data. The diameters of the QDs determined from these images were about 6 to about 7 m.

### Example IX

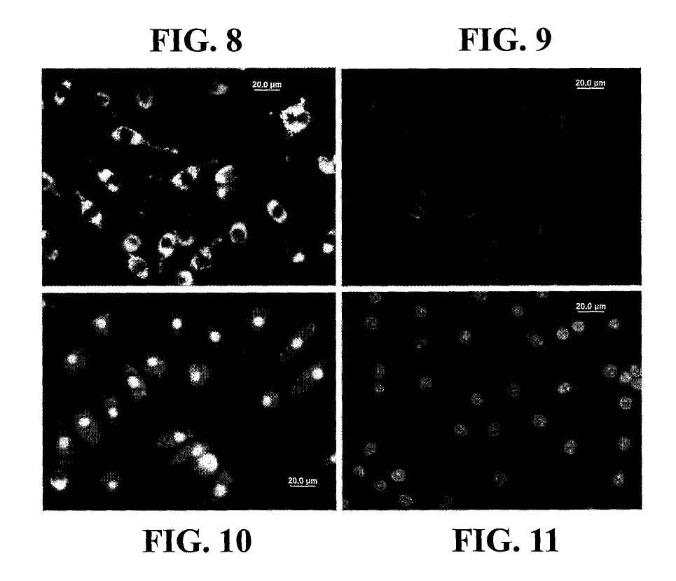

Both live and fixed RAW264.7 macrophage cells were incubated with cGSH-QDs conjugated with doxorubicin samples prepared in Example VI. After 4 hours of incubation, the fluorescence images of the samples were obtained. FIGS. 8, 9, 10, and 11 are fluorescence images of macrophage RAW264.7 cells labeled with sample quantum dots. For FIGS. 8 and 10 the cells were live and for FIGS. 9 and 11 the cells were fixed. The QDs used were cGSH-CdSe/CdS/ZnS QDs for FIGS. 8 and 9, and are doxorubicin-conjugated cGSH-CdSe/CdS/ZnS QDs for FIGS. 10 and 11. For these images, the fluorescence emission wavelength was 560 nm.

As can be deduced from the figures, cGSH-QDs only stained the cytoplasmic region of the cells (see FIGS. 8 and 9). The doxorubicin-conjugated cGSH-QDs successfully entered the nuclei of both live and fixed cells (see FIGS. 10 and 11).

As mentioned before, there are one thiol, one amine and two carboxylate groups on each GSH molecule. After crosslinking, many of these functional groups remain available and accessible for conjugation with bioprobes. As the sizes of the cGSH-QDs are small, they can be bioconjugated with a small molecule, such as doxorubicin, as demonstrated herein. The conjugated doxorubicin can bind tightly to a DNA and deliver nanoparticles into the nuclei of live cells. The conjugation can be based on the coupling between the carboxylate group of cGSH-QDs and the amine group of doxorubicin, induced by EDC/NHS as described above.

### Example X

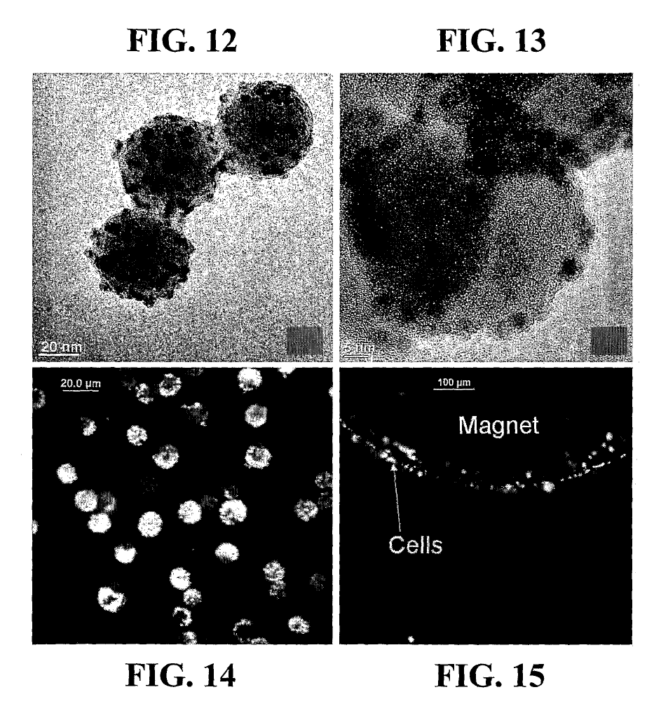

TEM images of the sample nanocomposite particles formed of SiO₂-γ-Fe₂O₃ MPs conjugated with cGSH-CdSe/CdS/ZnS QDs as prepared in Example VII were taken. Two representative TEM images at different magnification are shown in FIGS. 12 and 13. In these images, the diameter of the γ-Fe₂O₃ core crystal was about 11 nm, the diameter of the SiO₂-γ-Fe₂O₃ nanoparticles was about 45 nm, and the diameter of cGSH-QDs was about 6˜7 nm. As can be determined for the images, more than 50 cGSH-QDs were conjugated with a single silica-coated iron oxide (SiO₂-γ-Fe₂O₃) MP.

The fluorescence of macrophage RAW264.7 cells incubated with these nanocomposite particles was also detected. Representative images at different magnification are shown in FIGS. 14 and 15. The fluorescence emission wavelength for the yellow QDs was 570 nm. After incubation, the cells were fixed and stained with blue fluorescent 4′-6-Diamidino-2-phenylindole (DAPI). As can be seen, the samples showed bright fluorescence (FIG. 14) and excellent magnetic properties (as indicated in FIG. 15, where a circular magnet was placed at the top of the image and the cells conjugated with the particles, shown as brighter dots, were attracted towards the magnet).

For clarity, it should be understood that the term “or” when used herein in a list of items indicates that each of the listed items is itself a possible alternative and that any combination of any two or more of the listed items is also a possible alternative, excluding any combination that is not suitable, as would be understood by a skilled person in the art. For example, a combination including items that are mutually exclusive or are incompatible with one another should be excluded.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of forming a light emissive nanostructure, comprising:
providing a quantum dot;
forming a crosslinked-glutathione layer around said quantum dot.

2. The method of claim 1, wherein said forming said crosslinked-glutathione layer comprises crosslinking glutathione around said quantum dot.

3. The method of claim 2, wherein said crosslinking comprises mixing said glutathione around said quantum dot with an activating agent and free glutathione in a solution.

4. The method of claim 3, wherein said solution comprises a plurality of glutathione-capped quantum dots, a molar ratio of said free glutathione to said quantum dots in said solution being higher than 100.

5. The method of claim 4, wherein a molar concentration of said quantum dots in said solution is from about 0.01 μM to about 100 μM.

6. The method of any one of claims 3 to 5, wherein said solution comprises water.

7. The method of any one of claims 3 to 6, wherein said solution comprises an organic solvent.

8. The method of any one of claims 3 to 7, wherein said activating agent comprises carbodiimide.

9. The method of claim 8, wherein said carbodiimide is 1-ethyl-3-(3-dimethylaminopropyl)carbodiimide hydrochloride (EDC) or diisopropyl carbodiimide (DIC).

10. The method of any one of claims 3 to 9, wherein said activating agent comprises N-hydroxysuccinimide (NHS).

11. The method of any one of claims 1 to 10, wherein said crosslinked-glutathione layer around said quantum dot has an external diameter of less than 12 nm.

12. The method of claim 11, wherein said diameter is from about 4 to about 7 nm.

13. The method of any one of claims 1 to 12, wherein said quantum dot comprises a CdTe, CdSe, ZnSe, ZnCdSe, CdS, ZnS, PbS, Ag, or Au crystal.

14. The method of claim 13, wherein said quantum dot is a CdTe crystal.

15. The method of claim 13, wherein said quantum dot comprises a CdSe crystal core, a first shell around said core, and a second shell around said first shell, said first shell comprising CdS, and said second shell comprising ZnS.

16. A light emissive nanostructure comprising a quantum dot and a crosslinked-glutathione layer around said quantum dot.

17. The light emissive nanostructure of claim 16, having an external diameter of less than 12 nm.

18. The light emissive nanostructure of claim 17, wherein said diameter is from about 4 to about 7 nm.

19. The light emissive nanostructure of any one of claims 16 to 18, wherein said quantum dot comprises a CdTe, CdSe, ZnSe, ZnCdSe, CdS, ZnS, PbS, Ag, or Au crystal.

20. The light emissive nanostructure of claim 19, wherein said quantum dot is a CdTe crystal.

21. The light emissive nanostructure of claim 19, wherein said quantum dot comprises a CdSe crystal core, a first shell around said core, and a second shell around said first shell, said first shell comprising CdS, and said second shell comprising ZnS.

22. A method of coating a nanostructure, comprising:
providing a metal-based nanostructure; and
forming a crosslinked-glutathione layer coated on a surface of said metal-based nanostructure.

23. The method of claim 22, wherein said nanostructure has a volume of less than 0.001 μm³, and said forming comprises crosslinking glutathione coated on said nanostructure.

24. The method of claim 22 or claim 23, wherein said nanostructure is a metal-based nanotube, nanoneedle, nanorod, or nanowire.

25. The method of any one of claims 22 to 24, wherein said nanostructure comprises Cd, Zn, Pb, Cu, Ag, Au, or Hg.

26. A metal-based nanostructure coated with a crosslinked-glutathione layer.
